(19) United States
(12) Patent Application Publication
(10) Pub. No.: US 2008/0268898 A1
(43) Pub. Date: Oct. 30, 2008

(54) Identification Device Comprising a Transponder Integrated Into a Mobile Telephone

(75) Inventor: Mikael Willgert, Spanga (SE)

Correspondence Address: ALFRED J MANGELS, 4729 CORNELL ROAD, CINCINNATI, OH, 452412433, US

(73) Assignee: Tagmaster AB, Kista (SE)

(21) Appl. No.: 10/593,654

(22) PCT Filed: Mar. 17, 2005
(86) PCT No.: PCT/SE2005/000387

§ 371 Date: Jul. 2, 2008

(30) Foreign Application Priority Data
Mar. 22, 2004 (SE) 0400716-7

(51) Int. Cl. H04M 1/00; G08C 17/02

(52) U.S. Cl. 455/556.1; 340/10.1

(57) ABSTRACT

An identification device comprising a transponder (2) that can be read by means of a transmitter/receiver unit (11) arranged to transmit an enquiry signal (13) to the transponder, where the transponder is arranged to reflect (14) the enquiry signal and in this way to modulate the enquiry signal with information stored in a memory in the transponder and where the transmitter/receiver unit (11) is arranged to receive the modulated enquiry signal, which transponder (2) is integrated into a mobile telephone (8) and which transponder (2) is connected to a source (6) of power. The invention is characterised in that the said source (6) of power is constituted by the source of power of the mobile telephone used to power the clock of the mobile telephone (8).

The present invention relates to a transponder for an RFID-system, intended to be carried by persons.

It is becoming ever more common that persons are provided with transponders for the purpose of identification. Such transponders are read by what are known as “communicators” located at, for example, doors, in order to provide access control or to allow a person access to certain premises.

One problem is that the user must carry an identification token containing the said transponder at all times. It would be very advantageous to integrate an ID-token with another unit that the user normally carries, such as, a mobile telephone.

The patent application WO 01/39103, which has been submitted by the present applicant, describes a mobile telephone with an integrated reader for an RFID-system. The aim is to be able to read ID-tokens of the said type by means of a mobile telephone and to be able to transmit through the telephone system or through what is known as a “bluetooth” system information about such tokens to a supervisory system.

One advantage of integrating an ID-token with a mobile telephone is that the circuits of the mobile telephone can be used, to a large extent, also for the ID-token of RFID-type. This is described in the said patent application, on page 5.

However, a major problem with such an integration is that the ID-token functions only when the battery of the mobile telephone is sufficiently charged. However, an access control system, for example, depends upon all users having functioning ID-tokens.

The present invention solves this problem and offers a device that does not depend on the state of charge of the battery of the mobile telephone.

Thus the present invention relates to an identification device comprising a transponder that can be read by means of a transmitter/receiver unit arranged to transmit an enquiry signal to the transponder, where the transponder is arranged to reflect the enquiry signal and in this way to modulate the enquiry signal with information stored in a memory in the transponder and where the transmitter/receiver unit is arranged to receive the modulated enquiry signal, which trans-ponder is integrated into a mobile telephone and which trans-ponder is connected to a source of power, and the invention is characterized in that the said source of power is constituted by the source of power of the mobile telephone used to power the clock of the mobile telephone.

The invention is described in more detail below, partly in association with an embodiment of the invention shown on the attached drawings, where

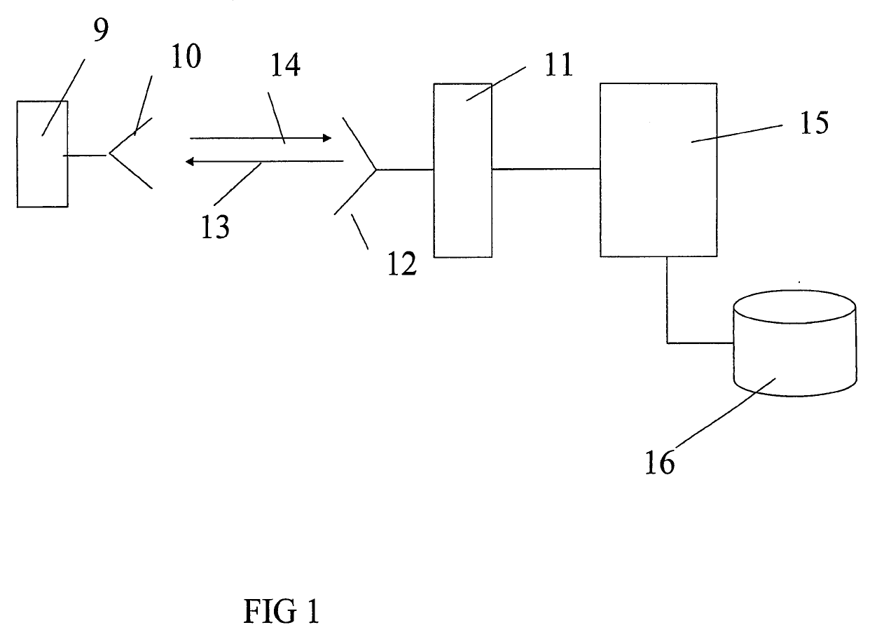

FIG. 1 shows schematically a communication link

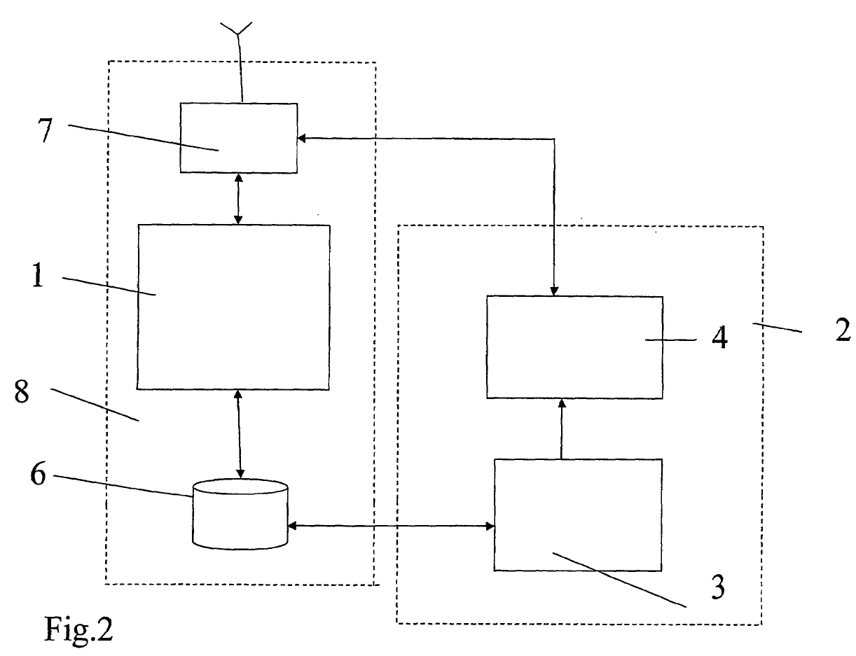

FIG. 2 shows schematically a mobile telephone with an integrated transponder.

There are a number of known automatic identification systems, known as “RFID” (Radio Frequency Identification) systems, that exploit radio frequencies, and that contain identification tokens (ID-tokens) and communicators. The applicant supplies such identification systems.

The ID-token is normally carried by the user.

The identity can be read by a communicator at a certain, short, distance, such as, for example, five to ten metres. It is also possible, depending on the design, to read and write other information into the ID-token with the aid of the communicator, in addition to reading an identity.

The relatively short range makes it possible to communicate with the ID-tokens within a geographically limited communication region.

FIG. 1 shows a communication unit for the identification of vehicles. The communication unit comprises a transponder 9 and a communicator in the form of a transmitter/receiver unit 11. The transponder comprises a circuit with memory and a modulator, together with an aerial 10. The communicator 11 also comprises an aerial 12, and is arranged to transmit an enquiry signal 13 to the transponder 9. The transponder is arranged to receive the enquiry signal and thereby to reflect 14 and modulate the enquiry signal. The communicator 11 is arranged to receive the reflected signal 14 and to decode its information content.

The information can contain at least information about the identity of the user.

The transmitter/receiver unit 11 is connected to a supervisory computer system that comprises a database 16 and a computer 15. The connection to the supervisory computer system can be executed by means of cable, radio, W-Lan, GSM/GPRS/G3 or similar.

The present invention relates to an identification device of the type described, where the transponder 2 is integrated into a mobile telephone 8. The transponder 2 exploits the aerial 5 of the mobile telephone 8, see FIG. 2.

According to the invention, a source of power for the trans-ponder 2 is constituted by the source 6 of power of the mobile telephone 8 for powering the clock of the mobile telephone 8, that is, the real-time clock. This source of power is normally a small battery, but other sources of power may be used.

The reference number 3 in FIG. 2 denotes a control circuit with its associated memory, and the reference number 4 denotes a modulator that is associated with the transponder 2. Further, the reference number 1 denotes the various electronic circuits of the mobile telephone 8.

The reference number 7 denotes a mixer of the type that is described in the above-mentioned patent application WO 01/39103, which is arranged to control incoming and outgoing signals to the aerial 5 of the mobile telephone 8 or to the transponder 2.

Alternatively, the circuit denoted by 7 may refer to a power divider or a directional coupler in order to be able to exploit the aerial 5 of the mobile telephone both for telephone communication and for RFID-communication. The power sharer or the directional coupler may be either passive or active.

The source 6 of power is, as FIG. 2 makes clear, connected both to the circuits 1 of the mobile telephone and to the transponder 2.

The transponder 2 can be more or less integrated into the circuits of the mobile telephone. However, according to one very important feature, all of the circuits that are necessary for the function of the transponder 2 are fed with power from the said source 6 of power.

It has proved to be the case that a passive transponder of the type described consumes so little power in order for the transponder to modulate and reflect an incoming enquiry signal 13 that the source of power for the clock of the mobile telephone 8 is sufficient.

This means that when a user, for example, passes a control passage the communicator will be able to identify the trans-ponder 2 even though the chargeable battery of the mobile telephone for the functions of the telephone is uncharged.

Thus, a mobile telephone will be able through the present invention to contain a working RFID transponder independently of the state of charge of the battery of the mobile telephone.

A number of embodiments have been described above. The invention, however, may be varied, for example, with respect to the degree of integration of the transponder.

The present invention, therefore, is not to be regarded as being limited to the embodiments specified above, since it can be varied within the scope of by the attached claims.

1. An identification device comprising a transponder (2) that can be read by means of a transmitter/receiver unit (11) arranged to transmit an enquiry signal (13) to the transponder, where the transponder is arranged to reflect (14) the enquiry signal and in this way to modulate the enquiry signal with information stored in a memory in the transponder and where the transmitter/receiver unit (11) is arranged to receive the modulated enquiry signal, which transponder (2) is integrated into a mobile telephone (8) and which transponder (2) is connected to a source (6) of power, characterized in that the said source (6) of power is constituted by the source power of the mobile telephone used to power the clock of the mobile telephone (8), where all the circuits that are necessary for the function of the transponder (2) are powered by the said source (6) of power.

2. An identification device according to claim 1, characterized in that it is arranged to exploit the aerial (5) of the mobile telephone during communication with the transponder.

3. An identification device according to claim 1, characterized in that the transponder is what is known as an “RFID” transponder.
